(19) United States
(12) Patent Application Publication
(10) Pub. No.: US 2006/0248468 A1
(43) Pub. Date: Nov. 2, 2006

(54) Apparatus and method for controlling visibility of data with visual nesting

(76) Inventors: Larry Constantine, Rowley, MA (US); Jeannine Aloe Strope, Longmont, CO (US); Rebecca Sue Ralston, Denver, CO (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/119,033

(22) Filed: Apr. 29, 2005

(51) Int. Cl. G06F 17/00; G06F 9/00

(52) U.S. Cl. 715/747; 715/835; 715/810; 715/840

(57) ABSTRACT

A method and apparatus are disclosed for displaying information in a visual scheme in which the visual scheme is assigned to a control button contained within a graphical user interface and assigned to a set of information associated with said control button, and in which the set of information is displayed within the assigned visual scheme when the control button is selected and the set of information is hidden when the control button is deselected. The method and apparatus are direct to a multi-level scheme that allows a user to quickly visually parse data in a complex document as well as individually view or turn off specific parts of the data hierarchy giving the advantage of efficient document consumption and flexible viewing. Because of the rules governing abstracts, this abstract should not be used in construing the claims.

### BACKGROUND

The present disclosure is directed generally to a graphical user interface (GUI) and, more particularly, to an interface for displaying structured data in a multi-level visual scheme.

Various types of interfaces are known in the art. For example, disclosed in US2004/0088115 A1 published May 6, 2004 and entitled “Method and Apparatus for Dynamic Checking and Reporting System Health” is a method and apparatus for remotely analyzing and affirmatively notifying appropriate personnel of problems and events associated with an oil recovery system comprising hundreds of oil rigs over a vast geographic area. The results of selected health checks, which are run on each oil rig, are reported to a central server. The central server populates a data base for the oil recovery system, displays a red/yellow/green color coded electronic notification and status for an entire oil recovery system and affirmatively alerts appropriate personnel of actions required to address events associated with an oil rig in an oil recovery system. The invention provides a dynamic oil rig status reporting protocol that enables population and display of a tree node structure representing an entire oil recovery system status on a single screen at a top level. Detailed information is available by drilling down in to other screens.

Another example is US2002/0152222 A1 published Oct. 17, 2002 and entitled “Apparatus and Method for Organizing and-or Presenting Data”. A “three dimensional” graphical user interface (GUI) is disclosed that enables the navigation of an unstructured list of data elements; e.g., search results of a database. The invention has the following features: (a) the data elements are classified within the leaf-nodes of a hierarchical category node tree; e.g., a library structure; (b) the engine for building the GUI requires only the following two attributes per data element: (i) a text string indicating the category path, and (ii) a URL for accessing the data element, an optional element description may also be included; (c) the invention enables implementation of an XML Application Program Interface (API) since the GUI engine operates independently of the library structure associated with the accessed database; (d) the GUI displays one hierarchical level at a time; (e) all aggregate elements are presented with paths that are implied, i.e., not expressly presented; (f) each level displays all matching sibling category nodes; and (g) any displayed category node can be “drilled-down” to the next lower hierarchical level of the category tree or drilled out to immediately access the data element. Further, in one GUI version, each node is presented as a circle with the node's corresponding category name. The size of the circle indicates the number of elements aggregate to that node, relative to the total number of data elements. The aggregate data elements of a category node are those elements that are classified within any leaf-node that falls below such category node. This aggregate number of data elements is also displayed within the circle. In another version, the GUI displays a subset of the list of data elements with the elements aggregate to a category node explicitly displayed as icons arranged in a cluster around the node's category name. Category names are color coded to indicate subsequent sub-categories. At any point during the GUI navigation, selecting any displayed icon will either display an optional element description or allow the user to “drill-out” or directly access data on a desired element without having to completely “drill-down” or access each subsequent category level or sub category using the GUI.

Another example is US 2003/0063134 A1 published Apr. 3, 2003 and entitled “System for Displaying a Hierarchical Directory” which discloses a segmented-tree system for web browser display of a selected part of a tree-structured directory of hierarchically-related entities in a computer system. In the segmented-tree design of the disclosed system, only the amount of information necessary to render the part of the tree in which the user is interested is transmitted from a server to the browser client. The server maintains information describing the complete tree, and it serves this information to the client in segments called ‘views’. The tree state for a particular client is maintained in relatively small data strings transferred back and forth. The server is thereby enabled to handle tree requests from many clients without special synchronization or the storage of the client state. Because the client/server tree state is kept in sync as the user navigates and modifies objects in the tree, the browser display always represents the true state of the tree.

Yet another example is U.S. Pat. No. 5,970,466 issued Oct. 19, 1999 and entitled “Graphical Computer System and Method for Appointment Scheduling”. That patent discloses a computer program stored in a storage medium and a computer-implemented method for scheduling appointments for an office or business which includes program code for displaying screen displays on a computer monitor, including a day view screen display with a plurality of thermometer-style schedules having a vertical bar graph opposite a daily appointment file having multiple rows for entering appointment data. A horizontal scroll bar allows the schedules to be displayed over a distance that is wider than a display area on the screen. The vertical bar graph includes color-coded bars to signify the status of appointments as: i) prior to check-in, ii) after check-in and iii) canceled appointments. In a “day view” schedules are arranged by selecting a group from a group list. The appointments can be predetermined as to type and duration, and a scheduler can refer to a list of such pre-configured appointments in scheduling patients. Various types of color-coding arrangements and icons are provided for patient status.

None of the various types of interfaces, however, is directed to aiding a user in viewing complex documents or forms comprising hierarchical or nested collections of information and/or data. Such an interface is desirable, for instance, for use by health care professionals when diagnosing conditions and creating a treatment regimen. More specifically, health care professionals may utilize a “plan of care” system for diagnosing problems, establishing treatment goals, and/or determining one or more treatment interventions. The plan of care system may contain a large amount of information that is hierarchical in nature and/or in a nested collection. Due to the amount of information in the plan of care system, and the inadequate interfaces currently used to display the information, it may be difficult for a health care professional to locate, track, and/or comprehend the desired information. This difficulty may prevent the health care professionals from using the plan of care system to its fullest potential, or even worse, deter the health care professional from using the plan of care system entirely.

Accordingly, a need exists for an interface that offers a multi-level scheme for flexibly controlling the display of information contained within complex documents or forms comprised of hierarchical and/or nested collections of information. More particularly, a need exists for an interface that offers a multilevel scheme for flexibly controlling the display of information contained within a plan of care system.

### SUMMARY

One aspect of the disclosure relates to a method for displaying information comprising assigning a visual scheme to a control button contained within a graphical user interface, assigning the visual scheme to a set of information, displaying the set of information within the assigned visual scheme when the control button is selected, and hiding the set of information when the control button is deselected. The visual scheme may be style, color, or both.

Another aspect of the disclosure relates to a computer readable medium carrying a set of instructions which, when executed, performs a method comprising assigning a visual scheme to a control button within a graphical user interface, assigning a visual scheme to at least one data set, and displaying the at least one data set within the assigned visual scheme when the control button is selected and hiding the at least one data set when the control button is deselected. The visual scheme may be style, color, or both.

Another aspect of the disclosure relates to a computer system comprising an input device, an output device, and a processing system. The processing system comprises a central processing unit and a data storage device in communication with the central processing unit, the data storage device being operable to store various software instructions and data sets related to a multi-level interface scheme, wherein the central processing unit is operable to access the data sets and execute the software instructions so as to assign a visual scheme to a control button within a graphical user interface, assign a visual scheme to at least one of the data sets, and display the at least one data set within the assigned visual scheme when the control button is selected and hide the set of information when the control button is deselected. The visual scheme may be style, color, or both.

Another aspect of the disclosure relates to a method for displaying information, the method comprising assigning a first visual scheme to a first set of information, assigning a second visual scheme to a second set of information, displaying the first set of information via a graphical user interface when the first set of information is selected, and displaying the second set of information via the graphical user interface when the second set of information is selected. The visual scheme may be style, color, or both.

### BRIEF DESCRIPTION OF THE DRAWINGS

For the present invention to be easily understood and readily practiced, the present invention will now be described, for purposes of illustration and not limitation, in conjunction with the following figures, wherein:

FIG. 1 illustrates a screen shot showing information displayed for a plan of care system using a multi-level interface scheme according to one embodiment.

FIG. 2 illustrates another screen shot showing information displayed for the plan of care system using the multilevel interface scheme according to the current embodiment.

FIG. 3 is a simplified diagram of a processing system on which the multi-level interface scheme for a plan of care system as shown in FIGS. I and 2 may reside according to one embodiment.

FIG. 4 is a simplified diagram of a computer system incorporating the processing system of FIG. 3 according to one embodiment.

### DETAILED DESCRIPTION

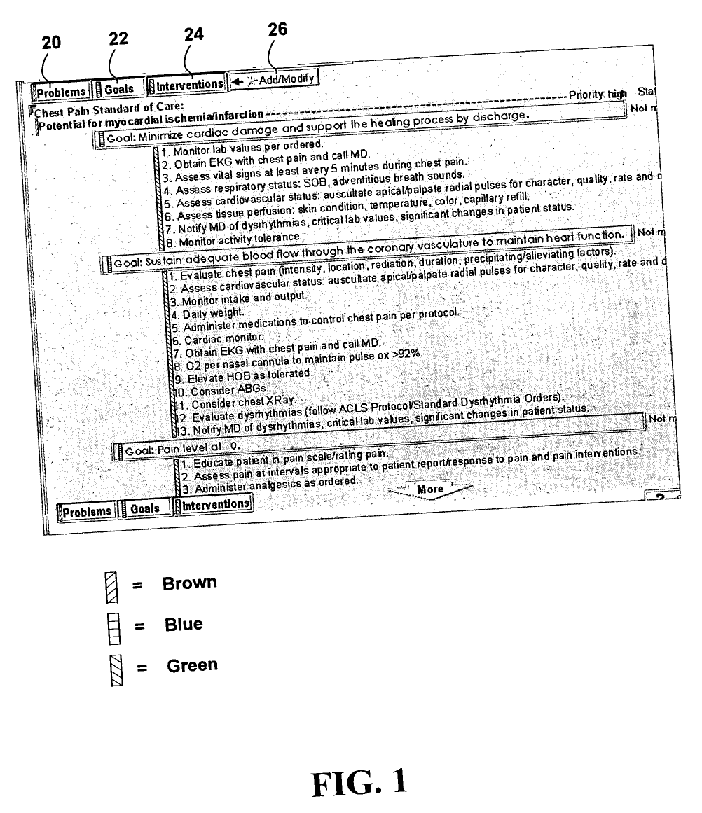

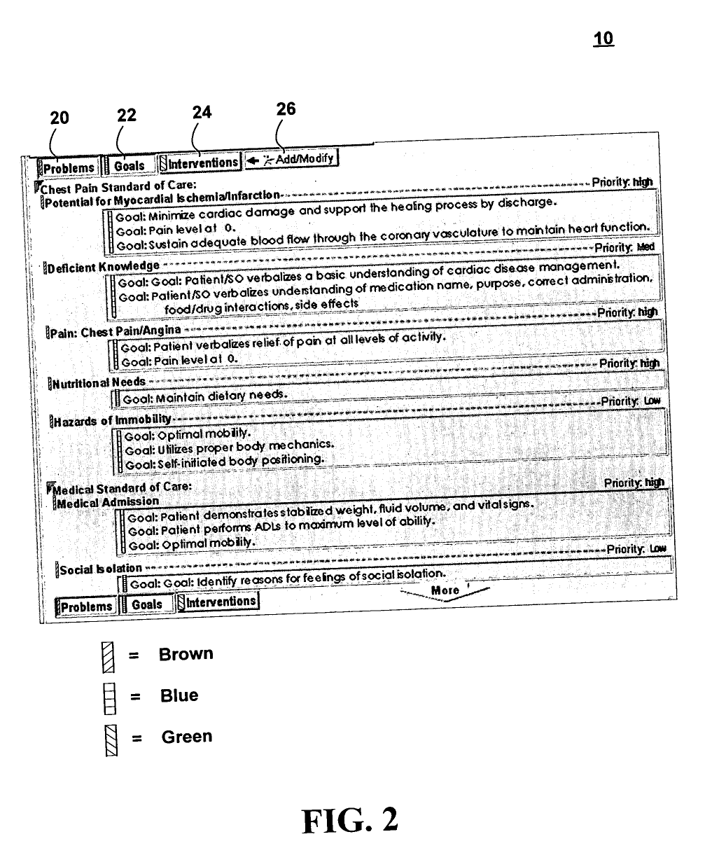

FIGS. 1 and 2 illustrate screen shots 10 showing information displayed for a plan of care system using a multi-level interface scheme according to one embodiment. As briefly discussed above, a plan of care system may contain a large amount of information that is hierarchical in nature and/or in a nested collection. Users, such as health care professionals, may utilize the plan of care system for diagnosing problems, establishing treatment goals, and/or determining one or more treatment interventions, among others. The plan of care system may be implemented, for example, on a desktop personal computer, a laptop personal computer, workstations, an electronic notebook, a personal digital assistant, etc. Although discussed in the context of the plan of care system, the reader will recognize the applicability of the present disclosure to displaying other types of information such that the present disclosure is not limited to any particular data being displayed.

The screen shots 10 illustrated in FIGS. 1 and 2 include a “problems” toggle button 20, a “goals” toggle button 22, and an “interventions” toggle button 24, among others. In the current embodiment, the problems 20, goals 24 and interventions 24 toggle buttons are each associated with a different color stripe. For example, the problems toggle button 20 is associated with a brown stripe (as illustrated by right-to-left diagonal crosshatching), the goals toggle button 24 is associated with a blue stripe (as illustrated by horizontal crosshatching), and the interventions toggle button 26 is associated with a green stripe (as illustrated by left-to-right diagonal crosshatching).

The problems 20, goals 22, and interventions 24 toggle buttons, combined with the color striping as devised for the plan of care system, enhance the user's ability to quickly locate, separate, and track information. It should be apparent to one skilled in art that alternative visual schemes may be utilized while remaining within the scope of the present invention. For example, different striping (e.g., double striped lines, thick/thin lines, etc.), alternative colors, style differentiation (e.g., italic-bold-underlined text, different fonts, etc.) and/or a combination thereof may be utilized.

It should further be apparent to one skilled in the art that the toggle buttons illustrated in FIGS. 1 and 2 are for exemplary purposes only and that the number of toggle button, the name/label of the toggle buttons, and the color/style associated with each toggle button may be altered while remaining within the scope of the present invention.

In the current embodiment, each of toggle buttons 20, 22, 24 is further associated with certain of the information contained within the plan of care system. The information within the plan of care system may be contained within a database. In the current embodiment, the information is organized in a hierarchical and/or nested manner. For example, a general category is given, problems related to that general category are listed thereunder, next goals related to a specific problem are listed (i.e., beneath the specific problem), and then interventions related to a specific goal are listed (i.e., beneath the specific goal). Referring to FIGS. 1 and 2, the general heading “Chest Pain Standard of Care” is illustrated for a treatment category. As best seen in FIG. 2, the related problems “Potential for myocardial ischemia/infarction”, “Deficient Knowledge”, “Pain: Chest Pain/Angina”, etc. are nested beneath the “Chest Pain Standard of Care” heading. Beneath “Potential for myocardial ischemia/infarction”, the goals “Minimize cardiac damage and support the healing process by discharge”, “Sustain adequate blood flow through the coronary vasculature to maintain heart function”, and “Pain level at 0” are nested. Beneath “Minimize cardiac damage and support the healing process by discharge” (as seen in FIG. 1), the interventions “Monitor lab values per ordered”, “Obtain EKG with chest pain and call MD”, etc. are nested.

In the current embodiment, the certain set of information associated with a particular toggle button is also associated with that toggle button's particular color stripe or other visual scheme/indicia (e.g., style). For example in FIG. 1 under the general heading “Chest Pain Standard of Care,” the information “Potential for myocardial ischemia/infarction” is associated with the problems toggle button 20, and thus, is also associated with a brown stripe. Similarly, the information “Goal: Minimize cardiac damage and support the healing process by discharge” is associated with goals toggle button 22, and thus, is also associated with a blue stripe. The information “Monitor lab values per ordered” is associated with interventions toggle button 24, and thus, is also associated with a green stripe. As discussed above, the color striping enhances the user's ability to quickly locate, separate, and track information within the plan of care system.

The toggle buttons 20, 22, 24 allow a user to control which information will be displayed by the plan of care system. In the current embodiment, selecting/deselecting a particular toggle button will display/hide the information associated therewith. Referring to FIG. 2, for example, the problems 20 and goals 22 toggle buttons are selected, whereas the interventions toggle button 24 is deselected. Accordingly, only the information associated with the problems 20 and goals 22 toggle buttons is displayed; the information associated with the interventions toggle button remains hidden. Referring to FIG. 1, in contrast, the interventions toggle button 24 is selected (the problems 20 and goals 22 toggle buttons remain selected). Accordingly, the information associated with each of the problems 20, goals 22, and interventions 24 toggle buttons is displayed. As should be apparent to one skilled in the art, the toggle buttons 20, 22, 24 allow a user to “drill down” and/or “drill out” to find desired information.

Although organized in a hierarchical and/or nested manner, a user may display/hide any set of information, or any combination of sets of information, independently of the other sets or combination of sets of information. In the current embodiment, the user may even display information contained within a lower level of the hierarchy while hiding information within a higher level of the hierarchy. For example, by selecting the goals toggle button 22 and deselecting the problems 20 and interventions 24 toggle buttons, a user may view only the goals information related to one or more general categories (e.g., the “Chest Pain Standard of Care”). The selected goals information (e.g., “Minimize cardiac damage and support the healing process by discharge”, “Sustain adequate blood flow through the coronary vasculature to maintain heart function”, “Pain level at 0”, etc.) is displayed with its associated visual scheme (i.e., a blue stripe) so as to allow the user to quickly determine which set of information is being viewed. As another example, by selecting the interventions toggle button 24 and deselecting the problems 20 and goals 22 toggle buttons, a user may view only the interventions information related to one or more general categories, for instance, the “Chest Pain Standard of Care” general category. The selected interventions information (“Monitor lab values per ordered”, “Obtain EKG with chest pain and call MD”, etc.) is displayed with its associated visual scheme (i.e., a green stripe) so as to allow the user to quickly determine which set of information is being viewed.

As seen in either FIG. 1 or FIG. 2, a “more” arrow button at the bottom of the display may be used to both notify a user that addition information is available and permit the user to scroll down to view the additional information. It should be apparent to one skilled in the art that other devices may serve the “notify” and/or “scroll” functions (for example, a scroll bar) while remaining within the scope of the present invention.

Additionally, an add/modify toggle button 26 may be provided on the display. The add/modify toggle button 26 enables a user to add/delete/modify the data displayed by the plan. For example, a user may add another problem beneath the general heading “Chest Pain Standard of Care,” modify the “Pain level at 0” to “Minimize pain”, etc. using the add/modify button 26.

This multi-level interface scheme allows a user to visually parse the data in a complex document quickly as well as individually view or turn off specific parts of the information hierarchy. This gives the advantage of efficient document consumption and flexible viewing. In the current embodiment, the multi-level interface scheme is implemented in a computer executable instruction set/code and may reside on a computer readable medium. The computer executable instruction set/code may be implemented in a stand-alone programming module compatible with other computing applications and/or integrated as a part of another computing application, among others. Although the multi-level interface scheme has been discussed in connection with a plan of care system, it should be noted that other applications might utilize the multi-level interface scheme while remaining within the scope of the present invention.

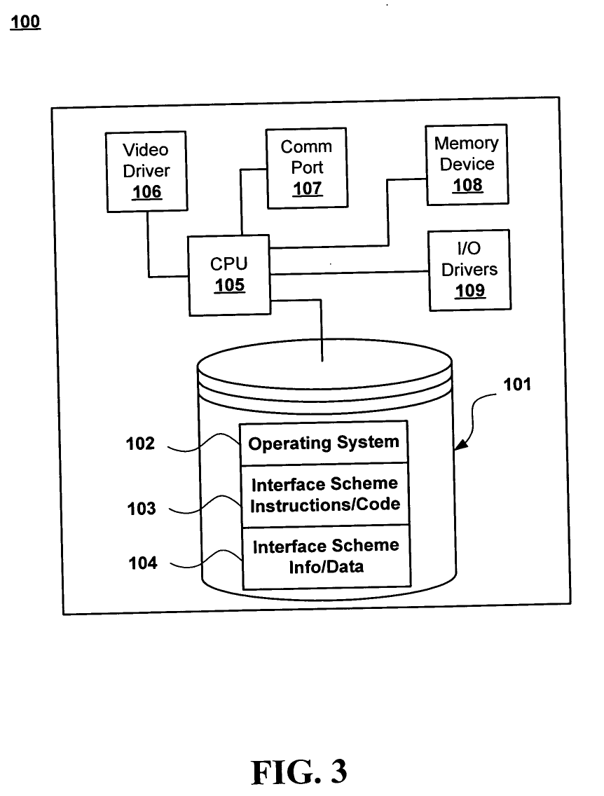

FIG. 3 is a simplified diagram of a processing system 100 on which the multi-level interface scheme for a plan of care system may reside according to the current embodiment. The processing system 100 may include a central processing unit (CPU) 105 in communication with a data storage device 101, a video driver 106, a communications port 107, a memory device 108, and an input/output driver 109, among others. The CPU 105 may be a microprocessor, micro-controller, and ASIC, among others. The CPU 105 is capable of performing various computing functions, such as executing software functions to perform specific calculations and/or data processing tasks. In the current embodiment, the CPU 105 is operable to implement the multi-level interface scheme as discussed above in conjunction with FIGS. 1 and 2.

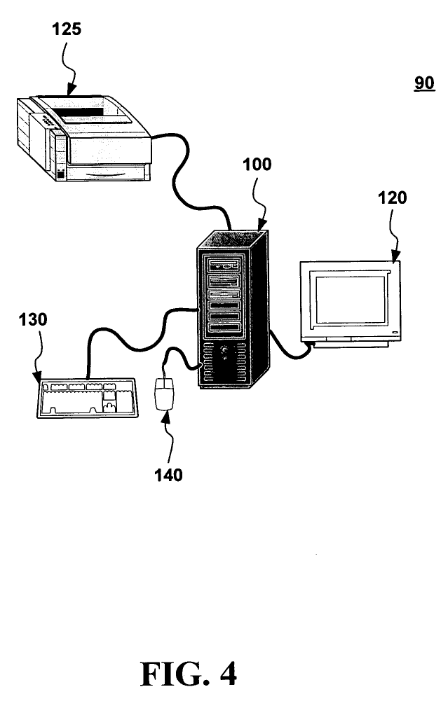

The data storage device 101 may be a CD-ROM, disk drive, tape drive, ZIP drive, etc. which is operable to store various software and data sets for use by processing system 100. In the current embodiment, the data storage device may be used to store an operating system 102 (e.g., Windows®, etc.), the instructions/code for the multi-level interface scheme 103, and a database containing data/information 104 (e.g., data/information for a plan of care), among others. The memory device 108 may be a dynamic random access module (DRAM), flash memory, static memory, read-only memory (ROM) device, etc. that may be used, for example, to temporarily store instructions and data that are frequently accessed by CPU 105. Video driver 106 is operable to drive a monitor (e.g., monitor 120 as illustrated in FIG. 4), communications port 107 provides an interface between the processing system 100 and one or more communication devices (not shown), and I/O driver 109 is an interface between various input devices (e.g., keyboard, mouse, microphone, bar code reader, RFID reader, touch screen, etc.) and output devices (e.g., printers, speakers, etc.).

FIG. 4 is a simplified diagram of a computer system 90 incorporating the processing system 100 of FIG. 3 according to one embodiment. The computing system 90 includes a keyboard 130 and mouse 140 connected to the processing system 100 (e.g., via I/O driver 109) to allow a user to manually input data, instructions, etc., to operate the processing system 100. The computing system also includes a monitor 120 and printer 125 connected to the processing system 100 (e.g., via video driver 106 and I/O driver 109, respectively) to display or otherwise output data generated by the processing system 100. Computing system 90 may also include mixed input/output devices (not shown) such as modems, network interface cards, and touch screens (among others) which may be connected of the processing system 100 (e.g., via communication port 107).

While the present invention has been described in connection with preferred embodiments thereof, those of ordinary skill in the art will recognize that many modifications and variations are possible. The present invention is intended to be limited only by the following claims and not by the foregoing description which is intended to set forth the presently preferred embodiment.

What is claimed is:

1. A method for displaying information, comprising:
assigning a visual scheme to a control button contained within a graphical user interface;
assigning said visual scheme to a set of information; and
displaying said set of information within said assigned visual scheme when said control button is selected and hiding said set of information when said control button is deselected.

2. The method of claim 1 further comprising:
assigning another visual scheme to another control button within said graphical user interface;
assigning said another visual scheme to a another set of information; and
displaying said another set of information within said assigned another visual scheme when said another control button is selected and hiding said another set of information when said another control button is deselected.

3. The method of claim 2 wherein said set of information and said another set of information are in hierarchical relationship with each other.

4. The method of claim 3 wherein said set of information and said another set of information may be displayed and/or hidden independently of one another.

5. The method of claim 1 wherein said visual scheme includes at least one of color or style.

6. A computer readable medium carrying a set of instructions which, when executed, performs a method comprising:
assigning a visual scheme to a control button within a graphical user interface;
assigning a visual scheme to at least one data set; and
displaying said at least one data set within said assigned visual scheme when said control button is selected and hiding said at least one data set when said control button is deselected.

7. The computer readable medium of claim 6 additionally comprising instructions for:
assigning another visual scheme to another control button within said graphical user interface;
assigning said another visual scheme to at least another data set; and
displaying said at least another data set within said assigned another visual scheme when said another control button is selected and hiding said at least another data set when said another control button is deselected.

8. The computer readable medium of claim 7 wherein said at least one data set and said at least another data set are in hierarchical relationship with each other.

9. The method of claim 8 wherein said at least one data set and said at least another data set may be displayed and/or hidden independently of one another.

10. The computer readable medium of claim 6 wherein said visual scheme includes at least one of color or style.

11. A computer system, comprising:
an input device;
an output device; and
a processing system, comprising:
a central processing unit; and
a data storage device in communication with said central processing unit, said data storage device being operable to store various software instructions and data sets related to a multi-level interface scheme,
wherein said central processing unit is operable to access said data sets and execute said software instructions so as to:
assign a visual scheme to a control button within a graphical user interface;
assign a visual scheme to at least one of said data sets; and
display said at least one data set within said assigned visual scheme when said control button is selected and hide said at least one data set when said control button is deselected.

12. The computer system of claim 11 wherein said central processing unit is further operable to:
assign another visual scheme to another control button within said graphical user interface;
assign said another visual scheme to at least another one of said data sets; and
display said at least another one of said data sets within said assigned another visual scheme when said another control button is selected and hide said at least another one of said data sets when said another control button is deselected.

13. The computer system of claim 11 wherein said at least one data set and said at least another one of said data sets are in hierarchical relationship with each other.

14. The method of claim 13 wherein said at least one data set and said at least another one of said data sets may be displayed and/or hidden independently of one another.

15. The computer system of claim 11 wherein said visual scheme includes at least one of color or style.

16. A method for displaying information, comprising:
assigning a first visual scheme to a first set of information;
assigning a second visual scheme to a second set of information;
displaying said first set of information via a graphical user interface when said first set of information is selected; and
displaying said second set of information via said graphical user interface when said second set of information is selected.

17. The method of claim 16 wherein said first set of information and said second set of information are in hierarchical relationship with each other.

18. The method of claim 17 wherein said first set of information and said second set of information may be displayed and/or hidden independently of one another

19. The method of claim 16 wherein said visual scheme includes at least one of color or style
